(19) United States
(12) Patent Application Publication
(10) Pub. No.: US 2005/0223148 A1
(43) Pub. Date: Oct. 6, 2005

(54) Electronic apparatus that communicates with host through serial communication interface

(75) Inventor: Ki-Hong Kim, Yongin-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/099,243

(22) Filed: Apr. 5, 2005

(30) Foreign Application Priority Data
Apr. 6, 2004 (KR) 2004-23468

(51) Int. Cl. G06F 13/00

(52) U.S. Cl. 710/260; 710/104

(57) ABSTRACT

A smart card that communicates with a host through a serial communication interface at variable transmission speed is provided, where the smart card variably controls the generation of a connection information signal in accordance with data transmission speed information received from the host to transmit the connection information signal to the host, to prevent errors from being generated due to the difference between the work waiting time in accordance with transmission speed set in the smart card and the work waiting time determined in accordance with actual transmission speed.

### CROSS-REFERENCE TO RELATED APPLICATION

This U.S. non-provisional patent application claims foreign priority under 35 U.S.C. § 119 to Korean Patent Application 2004-23468, filed on Apr. 6, 2004, the entire contents of which are hereby incorporated by reference.

### BACKGROUND OF THE INVENTION

The present disclosure relates to electronic apparatus that communicates with a host through a serial communication interface, and more particularly, to an electronic apparatus for transmitting connection information to a host.

FIG. 1 illustrates a connection between a host and an electronic apparatus through a serial communication interface. A host 10 and an electronic apparatus 20 include interfaces 11 and 21 for serial communications, respectively. There are a universal serial bus (USB) and a universal asynchronous receiver/transmitter (UART) in the serial communication interface. The UART is composed of microchips that include a program for controlling the interface between the host 10 and the electronic apparatus 20 and logic circuits. There are a computer and peripheral devices, such as serial devices like a modem or a card leader and a smart cart in the host 10 and the electronic apparatus 20 that can be connected to each other through the UART.

An example in which a card leader and a smart card are connected to each other through the UART that is an asynchronous communication interface as the serial communication interface will be described.

According to the UART specification, the UART generates and erases start, stop, and parity bits. Channel states such as stop conditions, frame structures, and overflow errors are transmitted to a processor by the UART. The processor transmits control signals such as line speed, word size, parity, and the number of stop bits to a UART chip. When data is transmitted, UART chips must convert inner parallel bytes into a serial bit stream using parallel/serial conversion. The bytes to be transmitted are supplied to the UART chips by the processor. When data is received, the UART chips do not receive any data while channels are in an idle state. When the channel states are changed, the UART chips determine the center of a starting bit and read data items of a predetermined bit from channels using sampling clocks at regular intervals. The UART chips such as Intel 8250 and Intel 8251, for example, are supposed to selectively use one among clocks of 64 times, 16 times, 8 times, and one time, in accordance with an inner mode based on the clock of 2.4576 MHz. For example, when the clock of 2.4576 MHz is divided in order to transmit data in the 16-times mode of 9600 bps, the clock of 153.6 MHz is generated such that data is transmitted by the clock divided per second. Such a clock dividing ratio or transmission speed is set by transmitting data from the UART 11 of the host 10 to the UART 21 of the electronic apparatus 20. Then, the UART 11 of the host 10 and the UART 21 of the electronic apparatus 20 transmit and receive data in accordance with the set transmission speed.

A smart card is typically a plastic card as large as a credit card, in which an integrated circuit chip is mounted that is capable of processing specific transactions by a microprocessor, a card operating system, a security module, and a memory. Smart cards may be divided into the categories of a contact card, a contactless card, and a hybrid card in accordance with a method by which data is read. When the contact card is inserted into an interface device that holds the same, the contact point of the contact card contacts the contact point of the interface device to activate the contact card. Such a card is used for fields in which a high degree of security is required, and it is required to perform specific encryption algorithms.

In the ISO-7816 specification that defines the serial communication protocol used for the smart card, the data transmission distance between a terminal and the smart card is strictly defined. The distance between the start leading edge of previous data transmitted by a card or a card reader to the start leading edge of the next data is defined not to exceed 960 elementary time units (ETU). The maximum delay between the start leading edge of the previous data to the start leading edge of the next data is referred to as work waiting time (WWT).

In particular, in order to confirm that connection between the card reader and the smart card is maintained, a null byte is supposed to be transmitted from the smart card to the terminal every WWT. That is, when the next data is not transmitted to the card reader and received from the card reader until the WWT passes after the last bit of data is transmitted to the card reader and received from the card reader, the smart card transmits the null byte to the card reader. The WWT defined by the ISO-7816 is not based on the clock supplied to the smart card but is based on the ETU that is the time spent on transmitting one bit. For example, that 1ETU is 12 means that one bit data is transmitted during the 12 periods of a clock signal. The ETU varies with the data transmission speed between the card reader and the smart card. Therefore, the WWT also varies with the data transmission speed between the card reader and the smart card.

FIG. 2 illustrates WWT in accordance with ETUs. 1ETU is the time spent on transmitting one bit data. When the WWT is the 960ETU, the smart card 20 transmits the null byte to the card reader 10 with the lapse of time for which 960 bits are transmitted from the end of the transmitted data.

The section (A) illustrates a data signal DAT and WWT when 1ETU is 12. When 1ETU is 12, the WWT is 960*12*T. T denotes one cycle of a clock signal. Therefore, the smart card 20 transmits the null byte to the card reader 10 when no data is transmitted to and received from the card reader 10 until the 960ETU (=960*12*T) passes after transmitting and receiving the i'th data byte (byte i).

The section (B) illustrates a data signal DAT and WWT when 1ETU is 24. When 1ETU is 24, the WWT is 960*24*T. Therefore, the smart card 20 transmits the null byte to the card reader 10 when no data is transmitted to and received from the card reader 10 until the 960ETU (=960*24*T) passes after transmitting and receiving byte i.

As described above, the UART chips are supposed to selectively use one among clocks of 64 times, 16 times, 8 times, and one time in accordance with an inner mode based on the clock of a predetermined frequency. When the smart card 20 is connected to the card reader 10, the UART 11 of the card reader 10 transmits transmission speed information to the UART 21 of the smart card 20. Then, the UARTs 11 and 21 transmit and receive data in accordance with set transmission speed. That is, the data transmission speed (i.e., ETU) between the card reader 10 and the smart card 20 is variable. However, when the smart card 20 is designed, WWT_{C} has a fixed value.

For example, as illustrated in FIG. 3, when the smart card 20 is designed to operate in 1ETU=24, the smart card 20 transmits the null byte to the card reader 10 when no data is transmitted to and received from the card reader 10 until the WWT_{C} (=960*24*T) passes after transmitting/receiving byte i to inform that the smart card 20 is still connected to the card reader 10.

When the data transmission speed between the card reader 10 and the smart card 20 is set as 1ETU=12, the card reader 10 sets work waiting time WWT_{H} (=960*12*T) based on 1ETU=12. The card reader 10 considers that the smart card 20 is not connected thereto when the (i+1)'th data byte (byte i+1) is not transmitted/received until the WWT_{H} passes after the i'th data (byte i) is transmitted/received. That the smart card 20 is considered not to be connected to the card reader 10 although the smart card 20 is connected to the card reader 10 means that communications between the smart card 20 and the card reader 10 are interrupted.

### SUMMARY OF THE INVENTION

A first exemplary embodiment of the present disclosure provides an electronic apparatus capable of changing the point of time at which a connection information signal is generated in accordance with transmission speed when communications with a host are performed through a serial communication interface at variable transmission speed.

A second exemplary embodiment of the present disclosure provides an electronic apparatus capable of changing the point of time at which a connection information signal is generated in accordance with transmission speed when communications with a host are performed through a serial communication interface at variable transmission speed and of providing the changed connection information signal to the host.

A third exemplary embodiment of the present disclosure provides a smart card capable of changing the point of time at which a connection information signal is generated in accordance with transmission speed when communications with a host are performed through a serial communication interface at variable transmission speed and of providing the changed connection information signal to the host.

A fourth exemplary embodiment of the present disclosure provides an electronic apparatus comprising a serial communication interface for receiving a data transmission speed information signal from the outside and a controller for variably controlling the generation of a connection information signal in accordance with the data transmission speed information signal from the serial communication interface.

According to a fifth embodiment of the present disclosure, the controller comprises a control logic circuit for receiving a clock signal and for generating a data start information signal that represents the start leading edge of data transmitted to or received from the serial communication interface and a timer reset by the data start information signal, the timer for activating an interrupt signal for variably controlling the generation of the connection information signal in accordance with the data transmission speed information signal from the serial communication interface. The control logic circuit generates the connection information signal in response to the interrupt signal.

The timer of the fifth embodiment comprises a first counter circuit for receiving a clock signal and for generating a pulse signal every period corresponding to the transmission speed information of the clock signal and a second counter circuit reset by the data start information signal, the second counter circuit for activating the interrupt signal for variably controlling the generation of the connection information signal every previously set period of the pulse signal.

The first counter circuit of the fifth embodiment comprises a first counter that operates in synchronization with the clock signal and a first comparator for generating the pulse signal when the value of the first counter reaches the value of the transmission speed information.

The second counter circuit of the fifth embodiment comprises a second counter that operates in synchronization with the pulse signal, a register for storing the value corresponding to the previously set period, and a second comparator for activating the interrupt signal when the value of the second counter reaches the value stored in the register.

The data transmission speed information signal of the fifth embodiment is a time information signal required for transmitting one bit data.

The serial communication interface of the fifth embodiment is an asynchronous serial communication interface and the asynchronous serial communication interface is a universal asynchronous receiver/transmitter (UART).

The serial communication interface of the fifth embodiment comprises a register for storing the data transmission speed information signal.

A sixth exemplary embodiment of the present disclosure provides an electronic apparatus comprising a serial communication interface for performing serial data transmission to a host and a controller for changing the generation of a connection information signal in accordance with a data transmission speed information signal provided by the host through the serial communication interface and for transmitting the connection information signal to the host through the serial interface.

The controller of the sixth embodiment comprises a control logic circuit for receiving a clock signal and for generating a data start information signal that represents the start leading edge of data transmitted to or received from the serial communication interface and a timer reset by the data start information signal, the timer for activating an interrupt signal for variably controlling the generation of the connection information signal in accordance with the data transmission speed information signal from the serial communication interface. The control logic circuit transmits the connection information signal to the host through the serial interface in response to the interrupt signal.

According to a seventh exemplary embodiment of the present disclosure, a smart card comprises a serial communication interface for performing serial data transmission to a host and a controller for changing the generation of a null byte signal in accordance with a data transmission speed information signal provided by the host through the serial communication interface and for transmitting the null byte signal to the host through the serial interface.

According to the seventh embodiment, the controller comprises a control logic circuit for receiving a clock signal and for generating a data start information signal that represents the start leading edge of data transmitted to or received from the serial communication interface and a timer reset by the data start information signal, the timer for activating an interrupt signal for variably controlling the generation of the null byte signal in accordance with the data transmission speed information signal from the serial communication interface. The control logic circuit transmits the null byte signal to the host through the serial interface in response to the interrupt signal.

The timer of the seventh embodiment comprises a prescaler for receiving a clock signal and for generating a pulse signal every period corresponding to the transmission speed information of the clock signal and a counter circuit reset by the data start information signal, the counter circuit for activating the interrupt signal for variably controlling the generation of the null byte signal every previously set period of the pulse signal.

The prescaler of the seventh embodiment comprises a first counter that operates in synchronization with the clock signal and a first comparator for generating the pulse signal when the value of the first counter reaches the value of the transmission speed information.

The counter circuit of the seventh embodiment comprises a second counter that operates in synchronization with the pulse signal, a register for storing the value corresponding to the previously set period, and a second comparator for activating the interrupt signal when the value of the second counter reaches the value stored in the register.

According to the seventh embodiment, an interval between the point of time at which the data start information signal is activated and the point of time at which the interrupt signal is activated is work-waiting time.

According to an eighth exemplary embodiment of the present disclosure, a method of controlling an electronic apparatus comprises the steps of receiving data transmission speed information from the outside and variably controlling the generation of a connection information signal in accordance with the data transmission speed information.

According to an ninth exemplary embodiment of the present disclosure, a method of controlling a smart card comprises the steps of receiving data transmission speed information from a host, variably controlling the generation of a connection information signal in accordance with the data transmission speed information, and transmitting the connection information signal to the host.

### BRIEF DESCRIPTION OF THE DRAWINGS

The accompanying drawings are included to provide a further understanding of the disclosure, and are incorporated in and constitute a part of this specification. The drawings illustrate exemplary embodiments of the present disclosure and, together with the written description, serve to explain principles of the present disclosure. In the drawings:

FIG. 1 illustrates an example of an electronic apparatus that communicates with a host through a serial interface;

FIG. 2 illustrates work waiting times (WWT) in accordance with elementary time units (ETU);

FIG. 3 illustrates a case in which the WWT in accordance with data transmission speed between a host and a smart card is different from the WWT set in the smart card;

FIG. 4 is a block diagram illustrating the internal structure of a smart card according to a preferred embodiment of the present disclosure;

FIG. 5 is a block diagram illustrating the structure of a card controller according to the preferred embodiment of FIG. 4;

FIG. 6 illustrates a timer according to the preferred embodiment of FIG. 4;

FIG. 7 illustrates the detailed structure of a clock prescaler illustrated in FIG. 4; and

FIG. 8 is a flowchart illustrating the operations of the smart card of FIG. 4 according to this preferred embodiment of the present disclosure.

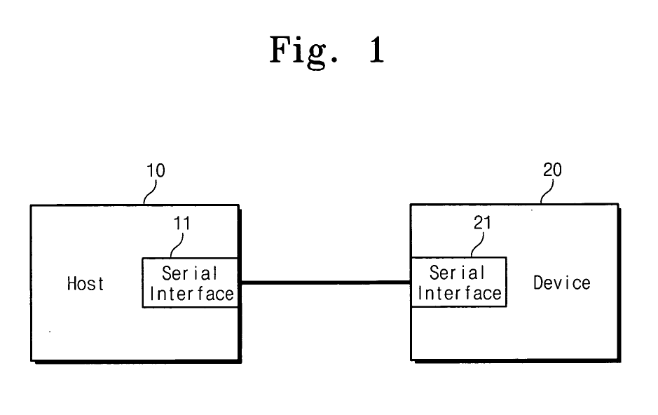

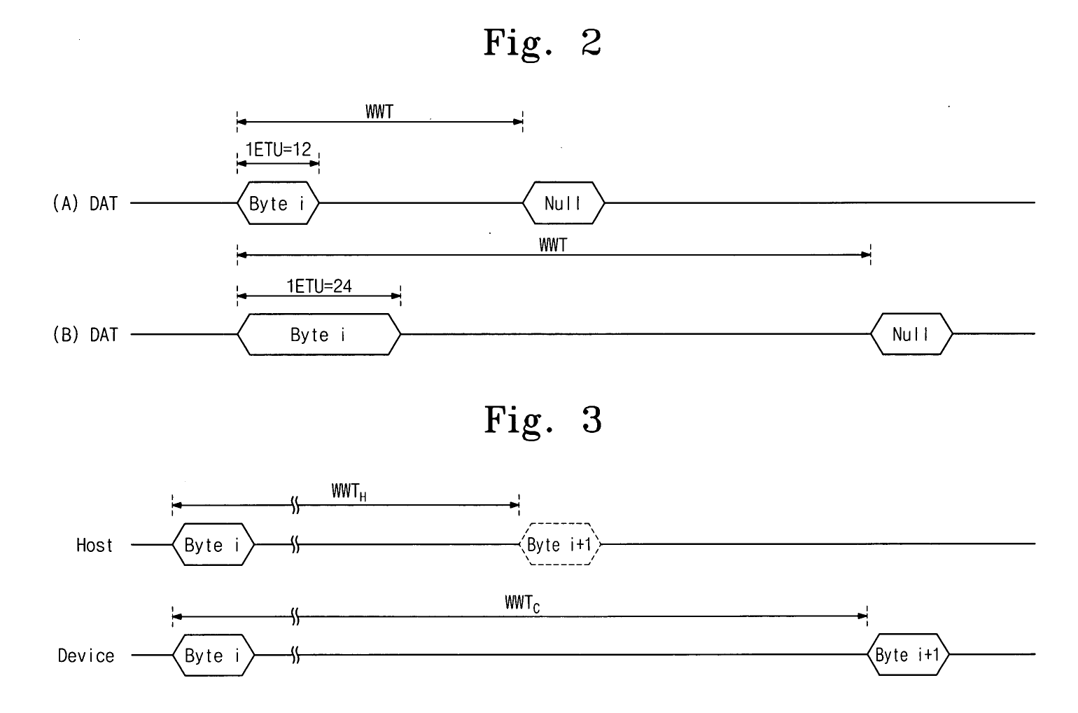

### DETAILED DESCRIPTION OF PREFERRED EMBODIMENTS

Preferred embodiments of the present disclosure will be described below in more detail with reference to the accompanying drawings.

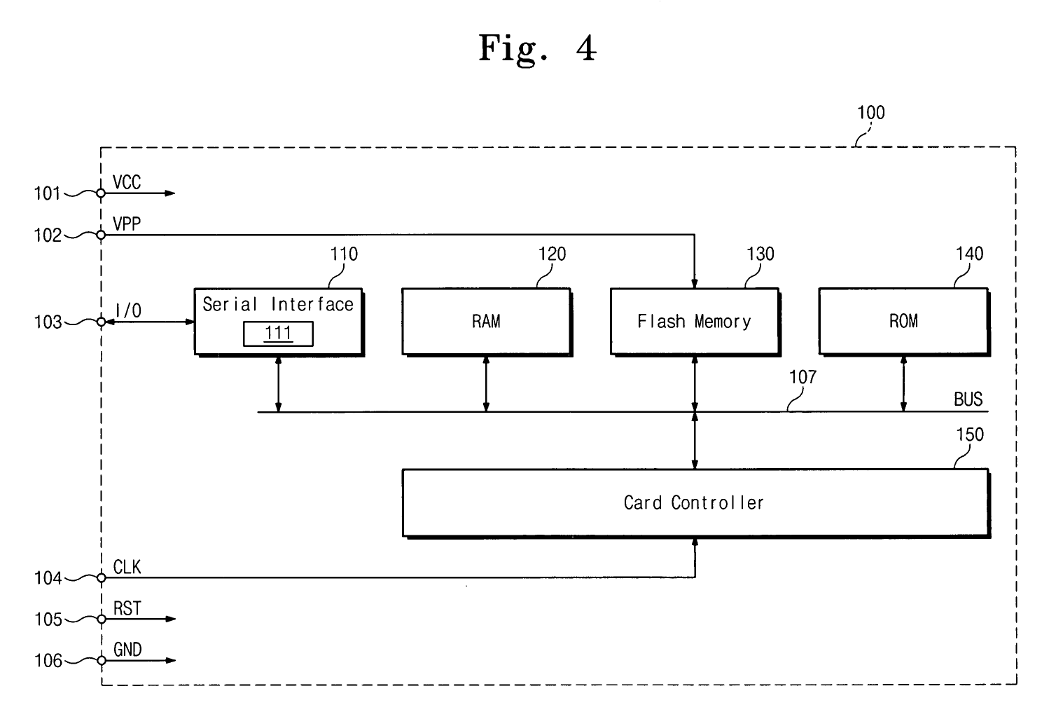

FIG. 4 is a block diagram illustrating the internal structure of a smart card according to a preferred embodiment of the present disclosure. A power source terminal 101, a power source terminal 102 for programming, an input and output terminal 103 for inputting and outputting bi-directional data, a clock input terminal 104, a reset input terminal 105, and a ground terminal 106 are provided to a smart card 100 as connection terminals for connecting the smart card 100 to an external apparatus or host.

The power source terminal 101 is used for supplying an operational power source VCC from the outside. The operational power source VCC is, for example, 5V or 3V.

The program power source terminal 102 is used for supplying a power source VPP for programming a built-in flash memory 130. The flash memory 130 is an electrically erasable non-volatile memory. The voltage of the program power source VPP applied to the flash memory 130 is commonly similar to the power source voltage VCC. The smart card 100 may include a device for generating the program power source VPP.

The bi-directional input/output terminal 103 is a data input/output terminal for actually inputting and outputting data through a bi-directional data signal line. Data is input to and output from the bi-directional data signal line through a serial interface 110. When no data is input and output, the voltage of the bi-directional data signal line is maintained almost equal to the operation power source voltage VCC and data can be transmitted between the external control device and the smart card 100.

A clock signal CLK is provided to the clock input terminal 104. The clock signal CLK makes a card controller 150 operable, where the controller is built into the smart card 100. The clock signal CLK is provided to the serial interface 110 and to the card controller 150.

A reset signal RST is provided to the reset input terminal 105. The reset signal RST is used for initializing the serial interface 110 as well as the card controller 150.

The input and output of data are performed through the bi-directional data signal line by the serial interface 110. The serial interface 110 may be an asynchronous serial interface such as a universal asynchronous receiver/transmitter (UART). The serial interface 110 converts the serial data transmitted from the external device into parallel data, such as 8 bits, for example.

A start bit of “L” level, which is logically a low level, exists in the head of the serial data input and output through the bi-directional data signal line. Bit data that has LSB-prior positive logic and final one bit of even parity are added to the head of the serial data. The head of the data is detected by the start bit of the “L” level and the data is sequentially transmitted. Errors are detected by parity. When errors are detected by the parity, a signal of the “L” level is transmitted from a receiver at the specific point of time between two clocks after the parity bit. Therefore, a transmitter can recognize the generation of errors. When the generation of errors is detected, the transmitter transmits the same data again.

Such a method is a half-duplex asynchronous communication protocol of ISO7816. The serial interface 110 performs conversion between serial data and parallel data by such a process.

The serial interface 110 includes a register 111 for storing a data transmission speed information signal ETU received from the host. The serial interface 110 divides the clock signal CLK in accordance with the data transmission speed information signal ETU stored in the register 111 to obtain the clock of data to be transmitted using the bi-directional data signal line. For example, the frequency division ratio is 1/372 in the smart card 100. The division ratio can vary with circumstances.

A random access memory (RAM) 120 is a memory from which data can be read and in which data can be written at any time. The RAM 120 is used for temporarily storing data when the card controller 150 performs processes.

The flash memory 130 is used for storing data that is continuously used and updated. The flash memory 130 can be replaced by an electrically erasable and programmable ROM (EEPROM).

The program to be processed by the card controller 150 is stored in a read only memory (ROM) 140.

A bus 107 is a path for transmitting commands, data, and control signal among the card controller 150, the serial interface 110, the RAM 120, the flash memory 130, and the ROM 140.

The card controller 150 performs processes in accordance with the commands input from the outside. The card controller 150 according to this preferred embodiment of the present disclosure controls work waiting time (WWT) in accordance with the data transmission speed provided from the host, to change the point of time at which a connection information signal that represents whether the smart card 100 is connected to the host is generated, and transmits the generated connection information signal to the host through the serial interface 110.

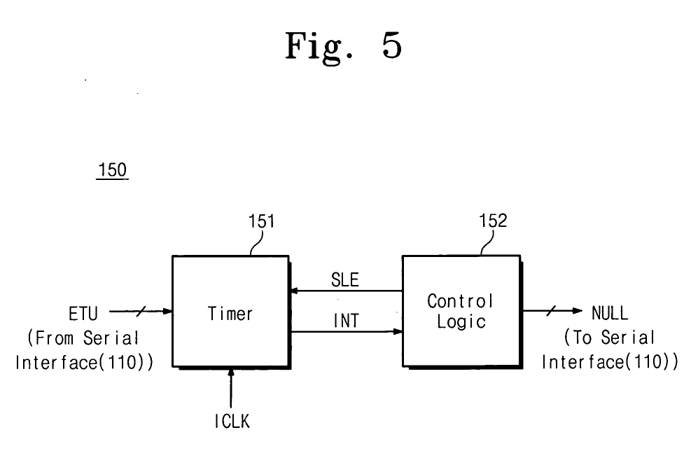

FIG. 5 is a block diagram illustrating the structure of the card controller 150 according to this preferred embodiment of the present disclosure. The card controller 150 includes a timer 151 and a control logic circuit 152.

The control logic circuit 152 provides the clock signal CLK input through the clock terminal 104 and a data start signal SLE to the timer 151. The SLE is enabled at the start of the data transmitted by the card or the card reader.

The timer 151 receives the data transmission speed information ETU from the serial interface 110. The transmission speed information signal ETU denotes time spent on transmitting one bit of data DAT and is stored in the register 111 of the serial interface 110. As described above, when 1ETU=12, one bit data is transmitted for the 12 periods of a clock signal.

The timer 151 receives the clock signal CLK and the data start signal SLE from the control logic circuit 152 and activates an interrupt signal INT for variably controlling the generation of the connection information signal in accordance with the transmission speed information ETU stored in the register 111 of the serial interface 110. The interrupt signal INT is provided to the control logic circuit 152. The control logic circuit 152 transmits a null byte that is a connection information signal to the host through the serial interface 110 when the interrupt signal INT is activated.

The timer 151 according to the preferred embodiment of the present disclosure receives the transmission speed information ETU set in the UART 110 to activate the interrupt signal INT. Therefore, it is possible to control the connection information signal, that is, to control the point of time at which the null byte is generated in accordance with the transmission speed between the host and the smart card 100.

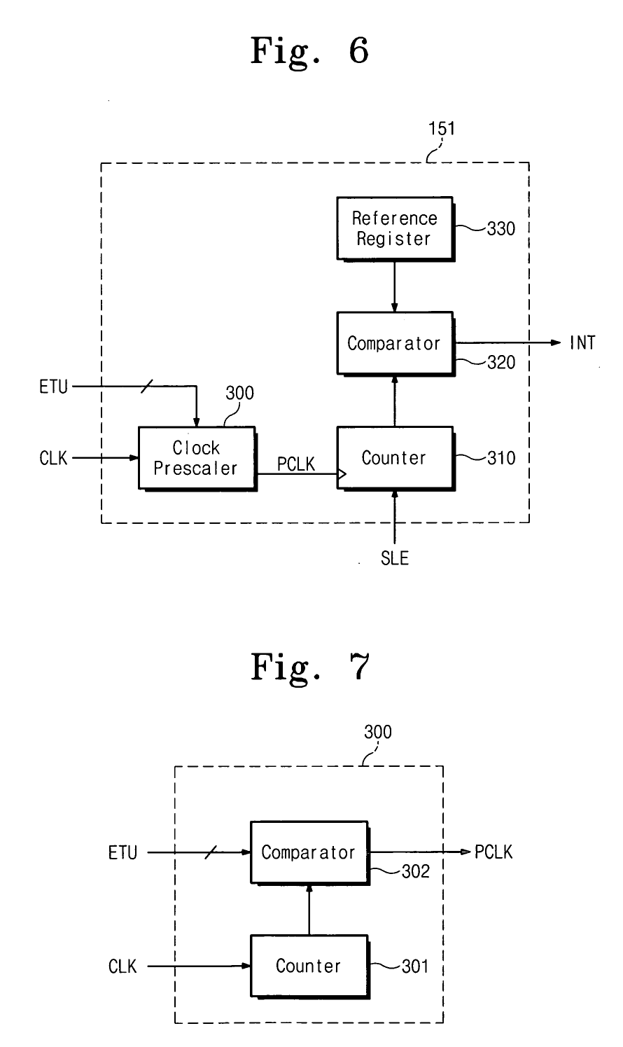

The timer 151 according to this preferred embodiment of the present disclosure is illustrated in FIG. 5. Referring to FIG. 6, the timer 151 includes a clock prescaler 300, a counter 310, a comparator 320, and a reference value register 330.

The clock prescaler 300 receives the clock signal CLK provided by the control logic circuit 152 and outputs a pulse signal PCLK with a period corresponding to the transmission speed information ETU provided by the serial interface 110. For example, when 1ETU=12, the clock prescaler 300 outputs the pulse signal PCLK every 12^{th} period of the clock signal CLK. The clock prescaler 300 can be realized by a divider. The period of the pulse signal PCLK is obtained by multiplying the ETU by the period T of the clock signal CLK. That is, the period of the pulse signal PCLK is equal to the time spent on transmitting the one bit data.

FIG. 7 illustrates the detailed structure of the clock prescaler 300 illustrated in FIG. 6. The clock prescaler 300 includes a counter 301 and a comparator 302. The counter 301 operates in synchronization with the clock signal CLK. The comparator 302 compares the counted value of the counter 301 with the operation speed information ETU and outputs the pulse signal PCLK when the counted value reaches the operation speed information ETU.

Referring to FIG. 6, the counter 310 is initialized by the data start signal SLE from the control logic circuit 122 and operates in synchronization with the pulse signal from the clock prescaler 300. The comparator 320 compares the counted value of the counter 310 with the reference value stored in the reference value register 330 and activates the interrupt signal INT when the two values coincide with each other.

The reference value stored in the reference value register 330 is the number of bits corresponding to the WWT. For example, when the reference value stored in the reference value register 330 is 960, the comparator 320 activates the interrupt signal INT when the counted value of the counter 310 is 960.

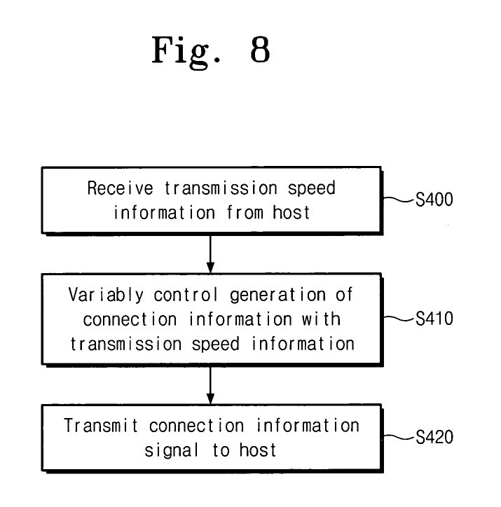

The operation of the smart card 100 of the above-described structure will be described in detail with reference to the flowchart illustrated in FIG. 8.

In step S400, the serial interface 110 receives the data transmission speed information signal ETU from the host. In step S410, the timer 151 variably controls the point of time at which the connection information signal, that is, the null byte, is transmitted in accordance with the data transmission speed information ETU. In step S420, the control logic circuit 152 transmits the connection information signal to the host through the serial interface 100.

For example, when the data transmission speed information signal ETU transmitted from the host and stored in the register 111 of the serial interface 110 is 12 and the reference value stored in the reference value register 330 is 960, the connection information signal, that is, the null byte is transmitted to the host when no data is transmitted/received until the 12*960 period of the clock signal passes after the data start signal SEL is enabled. As described above, since the point of time at which the smart card 100 generates the connection information signal is determined by the data transmission speed information transmitted from the host, a case in which the smart card 100 is considered not to be connected to the host due to the difference between the point of time at which the connection information signal is generated by the smart card 100 and the point of time where the connection information signal is received by the host does not occur although the smart card 100 is connected to the host. That is, the smart card 100 can correctly transmit the information signal that represents that the smart card 100 is connected to the host to the host 100 at the required point of time.

As described above according to preferred embodiments of the present disclosure, the smart card that communicates with the host through the serial bus at a variable transmission speed can automatically control the generation of the connection information signal, in accordance with the data transmission speed, to generate the connection information signal. Since the generation of the connection information signal is automatically controlled by the data transmission speed, it is possible to prevent errors from being generated due to the difference between the WWT in accordance with the data transmission speed set in the smart card and the WWT determined by the actual data transmission speed.

While this invention has been particularly shown and described with reference to preferred embodiments thereof, it will be understood by those of ordinary skill in the pertinent art that various changes in form and details may be made therein without departing from the spirit and scope of the invention as defined by the appended claims.

1. An electronic apparatus comprising:
a serial communication interface for receiving a data transmission speed information signal from the outside; and
a controller in signal communication with the serial communication interface for variably controlling the generation of a connection information signal in accordance with the data transmission speed information signal from the serial communication interface.

2. The electronic apparatus as set forth in claim 1, the controller comprising:
a control logic circuit for receiving a clock signal and generating a data start information signal that represents the start leading edge of data transmitted to or received from the serial communication interface; and
a timer in signal communication with the control logic circuit, reset by the data start information signal, for activating an interrupt signal for variably controlling the generation of the connection information signal in accordance with the data transmission speed information signal from the serial communication interface,
wherein the control logic circuit generates the connection information signal in response to the interrupt signal.

3. The electronic apparatus as set forth in claim 2, the timer comprising:
a first counter circuit for receiving a clock signal and for generating a pulse signal every period corresponding to the transmission speed information of the clock signal; and
a second counter circuit in signal communication with the first counter circuit, reset by the data start information signal, for activating the interrupt signal for variably controlling the generation of the connection information signal every previously set period of the pulse signal.

4. The electronic apparatus as set forth in claim 3, the first counter circuit comprising:
a first counter operable in synchronization with the clock signal; and
a first comparator in signal communication with the first counter for generating the pulse signal when the value of the first counter reaches the value of the transmission speed information.

5. The electronic apparatus as set forth in claim 4, the second counter circuit comprising:
a second counter that operates in synchronization with the pulse signal;
a register in signal communication with the second counter for storing the value corresponding to the previously set period; and
a second comparator in signal communication with the second counter and the register for activating the interrupt signal when the value of the second counter reaches the value stored in the register.

6. The electronic apparatus as set forth in claim 1, wherein the data transmission speed information signal is a time information signal required for transmitting one bit data.

7. The electronic apparatus as set forth in claim 1, wherein the serial communication interface is an asynchronous serial communication interface.

8. The electronic apparatus as set forth in claim 7, wherein the asynchronous serial communication interface is a universal asynchronous receiver/transmitter (UART).

9. The electronic apparatus as set forth in claim 1, wherein the serial communication interface comprises a register for storing the data transmission speed information signal.

10. An electronic apparatus comprising:
a serial communication interface for performing serial data transmission to a host; and
a controller in signal communication with the serial communication interface for changing the generation of a connection information signal in accordance with a data transmission speed information signal provided by the host through the serial communication interface and transmitting the connection information signal to the host through the serial communication interface.

11. The electronic apparatus as set forth in claim 10, the controller comprising:
a control logic circuit for receiving a clock signal and generating a data start information signal that represents the start leading edge of data transmitted to or received from the serial communication interface; and
a timer in signal communication with the control logic circuit, reset by the data start information signal, for activating an interrupt signal for variably controlling the generation of the connection information signal in accordance with the data transmission speed information signal from the serial communication interface,
wherein the control logic circuit transmits the connection information signal to the host through the serial interface in response to the interrupt signal.

12. The electronic apparatus as set forth in claim 11, the timer comprising:
a prescaler for receiving a clock signal and generating a pulse signal every period corresponding to the transmission speed information of the clock signal; and
a counter circuit in signal communication with the prescaler, reset by the data start information signal, for activating the interrupt signal for variably controlling the generation of the connection information signal every previously set period of the pulse signal.

13. The electronic apparatus as set forth in claim 12, the prescaler comprising:
a first counter operable in synchronization with the clock signal; and
a first comparator in signal communication with the first counter for generating the pulse signal when the value of the first counter reaches the value of the transmission speed information.

14. The electronic apparatus as set forth in claim 13, the counter circuit comprising:
a second counter operable in synchronization with the pulse signal;
a register in signal communication with the second counter for storing the value corresponding to the previously set period; and
a second comparator in signal communication with the second counter and the register for activating the interrupt signal when the value of the second counter reaches the value stored in the register.

15. The electronic apparatus as set forth in claim 10, wherein the data transmission speed information signal is a time information signal required for transmitting one bit data.

16. The electronic apparatus as set forth in claim 10, wherein the serial communication interface is an asynchronous serial communication interface.

17. The electronic apparatus as set forth in claim 16, wherein the asynchronous serial communication interface is a universal asynchronous receiver/transmitter (UART).

18. The electronic apparatus as set forth in claim 10, the serial communication interface comprising a register for storing the data transmission speed information signal.

19. A smart card comprising:
a serial communication interface for performing serial data transmission to a host; and
a controller in signal communication with the serial communication interface for changing the generation of a null byte signal in accordance with a data transmission speed information signal provided by the host through the serial communication interface and transmitting the null byte signal to the host through the serial communication interface.

20. The smart card as set forth in claim 19, the controller comprising:
a control logic circuit for receiving a clock signal and generating a data start information signal that represents the start leading edge of data transmitted to or received from the serial communication interface; and
a timer in signal communication with the control logic circuit, reset by the data start information signal, for activating an interrupt signal for variably controlling the generation of the null byte signal in accordance with the data transmission speed information signal from the serial communication interface,
wherein the control logic circuit transmits the null byte signal to the host through the serial communication interface in response to the interrupt signal.

21. The smart card as set forth in claim 20, the timer comprising:
a prescaler for receiving a clock signal and generating a pulse signal every period corresponding to the transmission speed information of the clock signal; and
a counter circuit in signal communication with the prescaler, reset by the data start information signal, for activating the interrupt signal for variably controlling the generation of the null byte signal every previously set period of the pulse signal.

22. The smart card as set forth in claim 21, the prescaler comprising:
a first counter operable in synchronization with the clock signal; and
a first comparator in signal communication with the first counter for generating the pulse signal when the value of the first counter reaches the value of the transmission speed information.

23. The smart card as set forth in claim 21, the counter circuit comprising:
a second counter operable in synchronization with the pulse signal;
a register in signal communication with the second counter for storing the value corresponding to the previously set period; and
a second comparator in signal communication with the second counter and the register for activating the interrupt signal when the value of the second counter reaches the value stored in the register.

24. The smart card as set forth in claim 20, wherein an interval from an activation time of the data start information signal to an activation time of the interrupt signal is a work waiting time.

25. The smart card as set forth in claim 19, wherein the data transmission speed information signal is a time information signal required for transmitting one bit data.

26. The smart card as set forth in claim 19, wherein the serial communication interface is an asynchronous serial communication interface.

27. The smart card as set forth in claim 26, wherein the asynchronous serial communication interface is a universal asynchronous receiver/transmitter (UART).

28. The smart card as set forth in claim 19, the serial communication interface comprising a register for storing the data transmission speed information signal.

29. A method of controlling an electronic apparatus, comprising the steps of:
receiving data transmission speed information from the outside; and
variably controlling the generation of a connection information signal in accordance with the data transmission speed information.

30. A method of controlling a smart card, comprising the steps of:
receiving data transmission speed information from a host;
variably controlling the generation of a connection information signal in accordance with the data transmission speed information; and
transmitting the connection information signal to the host.
